(19) United States
(12) Patent Application Publication
(10) Pub. No.: US 2002/0018332 A1
(43) Pub. Date: Feb. 14, 2002

(54) Arrangement having a contact element which can be brought into contact with another contact element

(76) Inventors: Matthias Kroeker, Ragow (DE); Martin Hanke, Berlin (DE)

Correspondence Address: Tyco Technology Resources, 4550 New Linden Hill Road, Suite 450, Wilmington, DE, 19808, US

(21) Appl. No.: 09/891,675

(22) Filed: Jun. 26, 2001

(30) Foreign Application Priority Data
Jul. 4, 2000 (DE) 10032650.1

(51) Int. Cl. H02H 1/00

(52) U.S. Cl. 361/133

(57) ABSTRACT

The arrangement described contains a device by means of which influence is exerted on an arc forming between the contact elements in such a way that the voltage established between the contact elements is increased, and a quenching device is provided which diverts and/or consumes energy supplied to the contact elements once a predetermined voltage is reached. An arrangement of this type makes it possible reliably and simply to prevent the contact elements and/or elements connected to the arrangement from being damaged or destroyed by effects occurring in particular when the contact elements are disengaged.

### FIELD OF THE INVENTION

The present invention relates to an arc suppression arrangement having an electrical contact element which can be brought into contact with another electrical contact element.

### BACKGROUND

Arrangements of this type are found for example in electrical switches, relays, connectors, etc. The contact elements for these arrangements are known as contact pieces in the case of electrical switches and relays or contact pins, contact tubes or surface contacts in the case of electrical connectors.

These contact arrangements have a problem in that under direct-current (DC) when the contact elements are disengaged or opened, arcing occurs which can damage or destroy the contact elements and/or devices connected to the arrangement. If such arcs are not extinguished rapidly, they can damage or even destroy the contact elements.

Various ways of rapidly extinguishing arcs or of preventing them even from occurring are already known. The most widely available ways are:

providing multiple contacts, for example providing an arrangement in which two contact points can be connected and disconnected by way of a bridge,

constructing the contacts within a vacuum chamber,

filling the contact area with a particular and/or pressurised gas, and

displacing the arc for example by use of a magnetic field or air flow away from the contact elements onto divergent electrical conductors which are connected to the contact elements. Additionally, where appropriate, providing arc-quenching plates between these conductors.

All these solutions have the disadvantage that they can only be produced with a very high level of complexity and result in large and expensive assemblies. Additionally, extinguishing the arc too quickly or preventing an arc from occurring can have the negative effect of spark-over between the contact elements which damages or destroys them, and/or devices connected thereto by the energy consumed in the arc.

### SUMMARY

An object of the present invention is therefore to provide an arrangement for simply and reliably preventing the contact elements and/or elements connected to the arrangement from being damaged or destroyed by detrimental effects described above which occur when the contact elements are disengaged.

This and other objects are achieved by providing an arrangement according to the invention having a device by means of which influence is exerted on an arc forming between the contact elements in such a way that the voltage established between the contact elements is increased. A quenching device is also provided which diverts and/or consumes energy supplied to the contact elements once a predetermined voltage is reached.

### BRIEF DESCRIPTION OF THE DRAWINGS

The invention will be described below in more detail by way of an example embodiment, and with reference to the figures, in which:

FIG. 1 shows a circuit containing an embodiment of the arrangement described in more detail below; and

FIG. 2 is a chart to illustrate the voltage and current relationships which are established with the arrangement shown in FIG. 1 once contact elements are disengaged.

### DETAILED DESCRIPTION OF THE PREFERRED EMBODIMENT

The arrangement of the present invention will now be described in greater detail. Although the embodiment will be described with respect to contacts of a relay, it should be understood that there is no restriction to this. The provision of the particular features described in more detail below also proves advantageous in other arrangements which have a contact element which can be connected to another contact element, for example in the case of a switch, a contactor or an electrical connector.

In the embodiment under consideration, actuating the relay makes or breaks a connection between an electrical circuit and a power or voltage source supplying the latter with energy. There is no restriction on this either. The particular features of the arrangement described in more detail below also prove advantageous in arrangements which have different functions to fulfill.

In the embodiment under consideration, the electrical circuit comprises a coil, for example a winding of an electric motor, and a resistor, but may also be of any other construction.

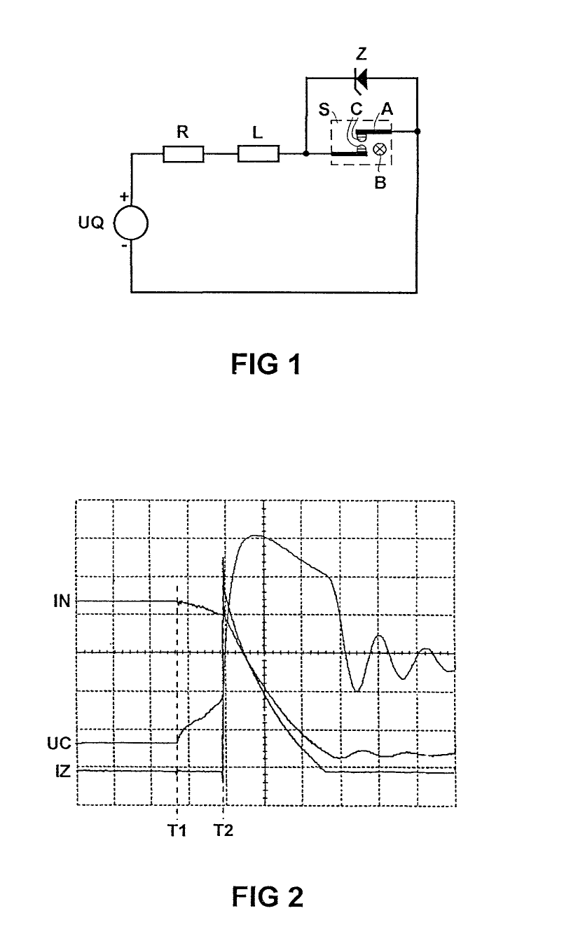

Referring to FIG. 1, the device shown has a DC voltage source UQ emitting a supply voltage, a resistor R connected to the positive pole of the voltage source UQ, a coil L connected in series with the resistor R, a switch S which is formed by a relay and arranged between the coil L and the negative pole of the voltage source UQ, and a Zener diode Z connected in parallel with the switch S.

For the sake of completeness, it should be noted that, only the contact elements C and the arms A which bear the contact elements C of the relay are shown. These arms A are moved relative to one another when the relay is actuated such that the contact elements C are brought into contact or disengaged from one another.

The arrangement moreover contains a magnet which generates a magnetic field in the region of the contact elements C. The lines of flux of this magnetic field run perpendicular to the direction along which an arc may be formed. When the contact elements C are disengaged. In some circumstances, however, an arc may be formed between these contact elements C when they are brought together. This magnetic field is designated by the reference symbol B in FIG. 1, however, the magnet itself is not illustrated in FIG. 1.

The magnet is preferably a permanent magnet, for example a neodymium iron boron magnet or a samarium cobalt magnet. Alternatively, it would also be possible to use an electromagnet.

The magnet, or to be more precise the magnetic field B generated thereby, and the Zener diode Z co-operate to ensure that an arc forming between the contact elements is extinguished rapidly. Once the arc has been extinguished, spark-over damaging or destroying the contact elements is controlled between the contact elements. Once the arc has been extinguished, damage or destruction of other parts of the system containing the arrangement is eliminated.

An arc between the contact elements C can occur when the contact elements C are disengaged, but in some circumstances also when they are brought together. If, as in the embodiment under consideration, a DC voltage is supplied and no suitable measures are taken to prevent it, this arc is sustained for a considerable period of time and may damage or destroy the contact elements. Arcs of this type can be expected with DC voltages from around 14 V; however, they may also occur if the system containing the arrangement described includes an inductor even at lower voltages.

The magnet operates as a device which is used to influence an arc forming between the contact elements C such that the voltage established between the contact elements is increased.

Without the magnetic field B, this voltage will be around 16 V, regardless of the contact spacing. A strong magnetic field can increase this voltage by a multiple. If, as in the example under consideration, the system containing the arrangement has an inductor and/or parasitic inductors, which is virtually always the case, the voltage established between the contact elements will even increase to a level which may be more or less far above the voltage to be supplied through the arrangement, which in the embodiment under consideration is the 42-volt supply voltage from the voltage source UQ.

For the sake of completeness, it should be noted that an arc forming between the contact elements C may also be influenced in another way than by a magnet such that the voltage established between the contact elements is increased.

The Zener diode Z operates as a quenching device which derives and/or consumes energy supplied to the contact elements C once a predetermined voltage is reached. This diverts the energy which the arc would need to be sustained and which once the arc has been extinguished can bring about spark-over between the contact elements.

For the sake of completeness, it should be noted that, as is known, it is also possible to derive and/or consume energy supplied to the contact elements C once a predetermined voltage is reached by means other than by a Zener diode, for example by a varistor.

In the preferred embodiment under consideration, the contact elements C have a diameter of approximately 2 to 3 mm, the contact elements C are at a spacing of approximately 0.1 to 0.4 mm when disengaged from one another, the DC voltage passed through the contact elements C is 42 V, and the aim is to extinguish an arc forming between the contact elements C within 1 ms.

This can be achieved without difficulty by a magnetic field B having a flux density of 100 mT or above and a Zener diode Z wherein the Zener voltage is only slightly above 42 V.

The conditions which are established when the switch S is opened will be described below with reference to FIG. 2.

In FIG. 2, the coil L has an inductance of 10 mH, the spacing between the disengaged contact elements C is 0.15 mm, and the flux density of the magnetic field B is 190 mT.

In FIG. 2, three lines UC, IZ and IN are illustrated, where:

the line UC shows the time curve of the voltage established between the contact elements C,

the line IZ shows the time curve of the current flowing through the Zener diode Z, and

the line IN shows the time curve of the current flowing through the circuit supplied with energy by way of the switch S.

The scaling of the voltages, currents and times illustrated in FIG. 2 is such that

the spacing between two adjacent horizontal grid lines corresponds to 20 V for line UC; 2.3 A for line IZ; and 2.7 A for line IN, and

the spacing between two adjacent vertical grid lines corresponds to 500 μs.

The switch S is initially closed, at time T1. In this condition:

the voltage UC between the contact elements C is 0 V,

the current IZ flowing through the Zener diode Z is 0 A, and

the current IN flowing through the circuit supplied with energy by way of the switch S is the current required by the consuming elements present therein.

At the point in time T1, the switch S is opened so that the contact elements C are disengaged from one another. At this point:

first an arc is formed between the contact elements C, which begins with a gradual increase in the voltage UC established between the contact elements,

the current IZ flowing through the Zener diode Z remains at 0 A, and

the current IN flowing through the circuit supplied with energy by way of the switch S falls slightly.

Moving on to a point in time approximately 700 μs after T1 and designated T2, at this point:

the voltage UC established between the contact elements C leaps abruptly as a result of the magnetic field B acting on the arc, and in so doing exceeds the voltage from which the Zener diode Z passes into the conductive condition,

the current IZ flowing through the Zener diode increases abruptly, and

the current IN flowing through the circuit supplied with energy by way of the switch S falls more sharply than before.

The current flowing through the Zener diode Z has the effect that:

the arc is extinguished, and

the voltage UC established between the contact elements C initially rises less steeply, then drops again, falling below the Zener voltage.

When the voltage UC established between the contact elements C falls below the Zener voltage:

the Zener diode Z passes into the blocking condition,

the voltage UC established between the contact elements C passes transiently to the voltage emitted by the voltage source UQ, and

the current IN flowing through the circuit supplied with energy by way of the switch S passes transiently to 0 A.

The Zener diode consumes 97% of the energy which was stored in the coil L at the time of the switch S opening. It should be clear that under these circumstances neither the contact elements nor other parts of the system containing the arrangement can be damaged or destroyed.

Use of the arrangement described is not only advantageous when, as in the example under consideration, operation is with DC; but the said advantages can also be achieved if operation is with low-frequency alternating currents.

The arrangement described makes it possible, regardless of the details of practical implementation, reliably and simply to prevent the contact elements C and/or elements connected to the arrangement from being damaged or destroyed by effects occurring in particular when the contact elements are disengaged.

The consumption and/or diversion of the energy supplied to the contact elements by the quenching element proves to be advantageous in a number of ways.

On the one hand, this diverts the energy which the arc would need to be sustained, as a result of which the arc can be extinguished in a simple manner at any point in time.

On the other hand, this also diverts the energy which could result in problems once the arc has been extinguished. Regardless of the duration or existence of the arc, there is no risk of spark-over, which damages or destroys the contact elements, between the contact elements and/or of damage or destruction of the elements connected to the contact elements.

As a result of the arrangement, it is possible reliably to prevent the contact elements and/or elements connected to the arrangement from being damaged or destroyed by effects occurring when the contact elements are disengaged.

The arrangements according to the invention can moreover be implemented simply and are not, or at least not to any considerable extent, larger than arrangements without the claimed special features. Rather, the opposite is the case. Because an arc only occurs for very brief periods and there is no risk of spark-over, the contact elements can be very small and have very small contact spacings.

The brief period of existence of the arc moreover has the positive effect that the arrangement emits less electromagnetic interference.

1. An arrangement having a contact element which can be brought into contact with another contact element, comprising a device by means of which influence is exerted on an arc forming between the contact elements in such a way that the voltage established between the contact elements is increased, and in that a quenching device is provided which diverts and/or consumes energy supplied to the contact elements once a predetermined voltage is reached.

2. An arrangement according to claim 1, wherein the device through which the arc forming between the contact elements is influenced is a magnet which is arranged and constructed such that it generates a magnetic field running transversely in relation to the arc in the region in which the arc forms.

3. An arrangement according to claim 2, wherein the magnetic field is so strong that within an extremely brief period after the arc has arisen, an abrupt increase in the voltage established between the contact elements is produced.

4. An arrangement according to claim 3, wherein the magnetic field is so strong that the abrupt increase in the voltage established between the contact elements is produced within 1 ms of the arc arising.

5. An arrangement according to claim 2 wherein a magnet is used which generates a magnetic field having a flux density of 100 mT or more in the region of the contact elements.

6. An arrangement according to claim 1 of wherein the predetermined voltage from which the quenching device consumes or diverts energy supplied to the contact elements is higher than the voltage which is established in a steady state when the contact elements are disengaged from one another and when there is no arc between the contact elements.

7. An arrangement according to claim 6, the predetermined voltage from which the quenching device consumes or diverts energy supplied to the contact elements is only slightly higher than the voltage which is established in the steady state when the contact elements are disengaged from one another and when there is no arc between the contact elements.

8. An arrangement according to claim 1 wherein the quenching device is arranged and constructed such that a current flows by way of it in the event of voltages lying above the predetermined voltage, and no current flows in the event of voltages lying below the predetermined voltage.

9. An arrangement according to claim 1 wherein the quenching device is a Zener diode.

10. An arrangement according to claim 9, wherein the Zener diode is provided in parallel with the contact elements.

11. An arrangement according to claim 1 wherein the arrangement is also used in systems in which the voltage in the steady state with contact elements not connected to one another, established between the latter, lies below the threshold value from which the formation of an arc is to be expected.

12. An arrangement according to claim 1 wherein the contact elements to be brought into contact are part of a switch.

13. An arrangement according to claim 1 wherein the contact elements to be brought into contact are part of a relay or a contactor.

14. An arrangement according to claim 1 wherein the contact elements to be brought into contact are part of electrical connectors to be connected to one another.

15. An arrangement according to claim 1 wherein a direct current or a low-frequency alternating current flows by way of the contact elements to be brought into contact in the mutually connected condition.
